(19) United States
(12) Patent Application Publication
(10) Pub. No.: US 2008/0264015 A1
(43) Pub. Date: Oct. 30, 2008

(54) Dust compressing apparatus of vacuum cleaner

(75) Inventors: Jang-Keun Oh, Gwangju-City (KR); Jin-Gon Lee, Gwangju-City (KR); Si-Chang Riu, Seoul (KR); Il-Du Jung, Gwangju-City (KR); Jung-Gyun Han, Gwangju-City (KR); Min-Ha Kim, Gwangju-City (KR); Seung-Yong Cha, Gwangju-City (KR); Hyoun-Soo Kim, Busan (KR); Dong-Houn Yang, Gwangju-City (KR); Hyun-Ju Lee, Gwangju-City (KR)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: SAMSUNG GWANGJU ELECTRONICS CO., LTD

(21) Appl. No.: 11/904,683

(22) Filed: Sep. 27, 2007

Related U.S. Application Data
(60) Provisional application No. 60/926,832, filed on Apr. 30, 2007.

(30) Foreign Application Priority Data
Jun. 18, 2007 (KR) 2007-59504

(51) Int. Cl. B01D 45/12

(52) U.S. Cl. 55/429

(57) ABSTRACT

A dust compressing apparatus of a vacuum cleaner that automatically compresses dust or dirt collected and stored in a dust separating apparatus. The dust compressing apparatus includes a compressing plate to compress dust or dirt collected in the dust separating apparatus, a lifting and lowering unit connected to the compressing plate above the compressing plate to lift and lower the compressing plate, and a driving motor to drive the lifting and lowering unit thus to lift and lower the compressing plate.

### CROSS-REFERENCE TO RELATED APPLICATIONS

This application claims the benefit under 35 U.S.C. §119(a) of U.S. Provisional Patent Application No. 60/926,832, filed Apr. 30, 2007, in the United States Patent and Trademark Office, and Korean Patent Application No. 10-2007-0059504, filed on Jun. 18, 2007, in the Korean Intellectual Property Office, the entire content of which is hereby incorporated by reference.

### BACKGROUND OF THE INVENTION

1. Field of the Invention

The present disclosure relates to a vacuum cleaner. More particularly, the present disclosure relates to a cyclone dust separating apparatus of a vacuum cleaner, which draws in external air and separates dust or dirt from the drawn-in air.

2. Description of the Related Art

In general, a cyclone dust separating apparatus provided in a vacuum cleaner is an apparatus, which whirls air laden with dirt or dust and separates the dirt or dust therefrom. Such a cyclone dust separating apparatus has been recently widely used because it can be semi-permanently used without any inconvenience of frequently replacing dust bags.

The cyclone dust separating apparatus usually has a cyclone structure, which includes a cyclone to make drawn-in air into a whirling current and thus to separate dust or dirt from the drawn-in air, an air inflow part to guide the drawn-in air to flow into the cyclone in a tangential direction thereof, and a dust bin to collect and store the separated dust or dirt therein. In the cyclone structure as described above, the dust or dirt is randomly accumulated in the dust bin by the whirling air in the cyclone when it is collected in the dust bin. Thus, the conventional cyclone dust separating apparatus presents a problem that the dust or dirt is apt to scatter along with the whirling air and to flow backward into the cyclone again and as a result, a dust-separating efficiency is deteriorated. In addition, since the dust or dirt is loosely accumulated in the dust bin, a time to fill the dust bin with the dust or dirt is not only shortened, so that a user should frequently empty the dust or dirt from the dust bin, but also a problem may occur, in that when the dust bin is emptied, the dust or dirt loosely accumulated in the dust bin is scattered to contaminate the surroundings.

To address the problems as described above, a vacuum cleaner having a dust compressing apparatus, which compresses dust or dirt in a cyclone dust separating unit, is disclosed in Japanese Patent Publication No. 2002-051950. The dust compressing apparatus of the vacuum cleaner is provided with a partition installed in the cyclone dust separating unit to compress the dust or dirt, and an operating handle connected to the partition to be ascendable and descendable in combination with a spring. Accordingly, as a user moves the operating handle down, the partition is descended to compress the dust or dirt in the cyclone dust separating unit. However, the dust compressing apparatus as described above is inconvenient in that to compress the dust or dirt in the cyclone dust separating unit, the user should manually move the operating handle down.

Also, another vacuum cleaner having a dust compressing apparatus, which compresses dust or dirt in a dust collecting chamber, is disclosed in Korean Patent Publication No. 10-2006-58052. The dust compressing apparatus of the vacuum cleaner is provided with a griping part to grip the vacuum cleaner, a lever disposed to be operable when a user grips the griping part, and a compressing member disposed in the dust collecting chamber to compress the dust or dirt in the dust collecting chamber through a linking mechanism when the lever is operated. Accordingly, when the user grips the griping part, the lever operates the compressing member through the linking mechanism to compress the dust or dirt in the dust collecting chamber. However, like the dust compressing apparatus of Japanese Patent Publication No. 2002-051950, the dust compressing apparatus as described above is inconvenient in that to compress the dust or dirt in the dust collecting chamber, the user should manually operate the griping part. Also, since the dust compressing apparatus as described above uses the linking mechanism, Which converts a straight-line motion of the lever into a rotation motion, converts the converted rotation motion into a straight-line motion again and then transmits the converted straight-line motion to the compressing member, a construction thereof is complicated. Accordingly, the dust compressing apparatus as described above is disadvantageous in that it is difficult to fabricate and a fabrication cost is increased.

### SUMMARY OF THE INVENTION

An aspect of the present disclosure is to address at least the above problems and/or disadvantages and to provide at least the advantages described below. Accordingly, an aspect of the present disclosure is to provide a dust compressing apparatus of a vacuum cleaner of automatically compressing dust or dirt collected and stored in a dust separating apparatus while having a relatively simple structure.

In accordance with an aspect of the present disclosure, a dust compressing apparatus of a vacuum cleaner includes a compressing plate to compress dust or dirt collected in a dust separating apparatus, a lifting and lowering unit connected to the compressing plate above the compressing plate to lift and lower the compressing plate, and a driving motor to drive the lifting and lowering unit thus to lift and lower the compressing plate.

Here, the compressing plate may be a circular plate. At this time, the circular plate may have a rubber lip formed on a circumferential edge thereof.

The lifting and lowering unit may include a threaded axis connected to the compressing plate and having a thread formed on an outer circumferential surface thereof, a cylindrical gear having a threaded hole formed on an inner circumferential surface thereof to engage with the threaded axis and outer circumferential teeth formed on an outer circumferential surface thereof to engage with a driving gear of the driving motor, and a supporting bracket to rotatably support the cylindrical gear. At this time, to prevent the cylindrical gear from raising along the threaded axis, preferably, but not necessarily, a raised portion is formed below the outer circumferential teeth.

The dust separating apparatus may include a first cyclone unit to separate the dust or dirt from air drawn in through an air inflow part, and a dust bin unit disposed below the first cyclone unit to collect and store the dust or dirt separated from the air in the first cyclone unit. At this time, preferably, but not necessarily, the dust bin unit include a dust bin in the form of cylinder, and to allow the dust or dirt to pass between the dust bin and the circular plate and then to be collected and stored in the dust bin, the circular plate is formed in such a diameter that a circumferential edge thereof is spaced apart from the dust bin with a certain gap.

Also, the first cyclone unit may include a single first cyclone, the first cyclone may include a cyclone body having the air inflow part formed therein, and a grill member disposed in the cyclone body while having a cylindrical shape, a lower end of which is choked and an upper end of which is opened, and having a plurality of penetrated holes. In this case, preferably, but not necessarily, the circular plate is disposed below the grill member, the threaded axis is extended over the upper end of the grill member while penetrating through the grill member, and the supporting bracket is disposed on an air guide plate connected with an upper part of the cyclone body.

To prevent the threaded axis from rotating along with the cylindrical gear, the lifting and lowering unit may have a rotation-preventing guide disposed between the circular plate and at least one of the cyclone body and the dust bin. The rotation-preventing guide may include a guide rib vertically formed on at least one of the cyclone body and the dust bin, and a guide groove formed in the circular plate to accommodate and guide the guide rib.

In accordance with another aspect of the present disclosure, the dust separating apparatus may further include a second cyclone unit having a plurality of second cyclones disposed to at least one of above and around the first cyclone unit.

### BRIEF DESCRIPTION OF THE DRAWING FIGURES

The above and other objects, features, and advantages of certain exemplary embodiments of the present disclosure will be more apparent from the following description taken in conjunction with the accompanying drawings, in which:

FIG. 1 is an exploded perspective view exemplifying an example of a cyclone dust separating apparatus of a vacuum cleaner to which a dust compressing apparatus according to an exemplary embodiment of the present disclosure is applied;

FIG. 2 is a cross-sectional view of the cyclone dust separating apparatus illustrated in FIG. 1;

FIG. 3 is a perspective view exemplifying a construction of a compressing plate of the dust compressing apparatus illustrated in FIG. 1;

FIGS. 4A and 4B are cross-sectional views exemplifying a dust compressing operation of the cyclone dust separating apparatus illustrated in FIG. 1;

FIG. 5 is a cross-sectional view exemplifying another example of a cyclone dust separating apparatus of a vacuum cleaner to which the dust compressing apparatus according to the exemplary embodiment of the present disclosure is applied; and

FIG. 6 is a perspective view exemplifying a construction of a supporting body of the cyclone dust separating apparatus illustrated in FIG. 5.

Throughout the drawings, the same reference numerals will be understood to refer to the same elements, features, and structures.

### DETAILED DESCRIPTION OF THE EXEMPLARY EMBODIMENTS

Hereinafter, a dust compressing apparatus of a vacuum cleaner according to certain exemplary embodiments of the present disclosure will be described in detail with reference to the accompanying drawing figures. Throughout the drawings, the same reference numerals will be understood to refer to the same elements, features, and structures.

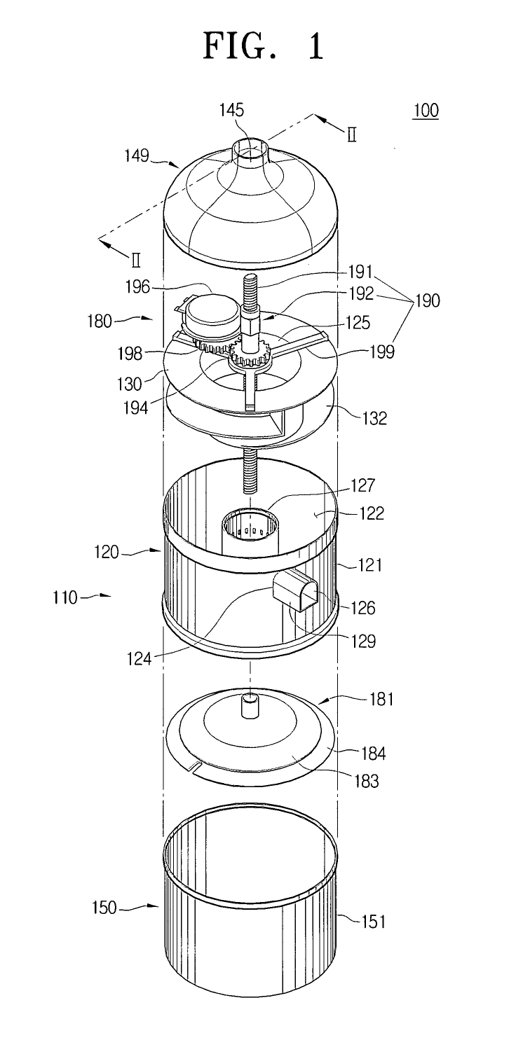

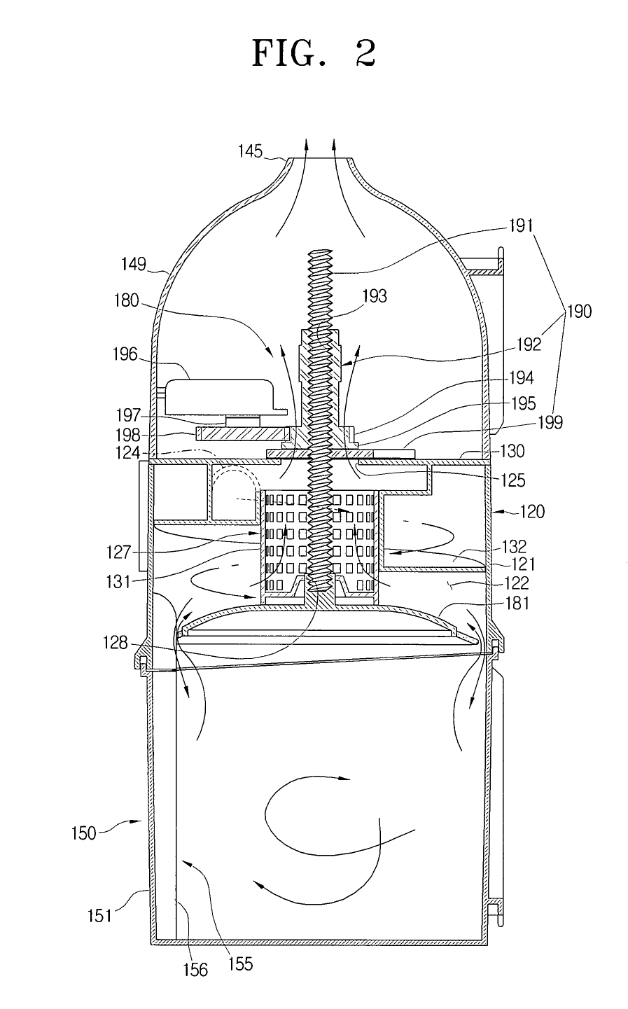

FIGS. 1 and 2 are an exploded perspective view and a cross-sectional view exemplifying an example of a cyclone dust separating apparatus 100 of a vacuum cleaner to which a dust compressing apparatus 180 according to an exemplary embodiment of the present disclosure is applied.

Referring to FIGS. 1 and 2, the cyclone dust separating apparatus 100 includes a cyclone unit 110, a cover member 149 joined to an upper part of the cyclone unit 110, a dust bin unit 150 joined to a lower part of the cyclone unit 110, and a dust compressing apparatus 180 to compress dust or dirt collected and stored in the dust bin unit 150.

The cyclone unit 110 is provided with a cyclone 120. The cyclone 120 is made up of a cyclone body 121, an inflow pipe 129 and a grill member 127. The cyclone body 121 is formed in an approximately cylinder shape, and forms a cyclone chamber 122.

The first cyclone body 121 at a lower part thereof is opened, and at an upper part thereof is opened through an air outlet 125 of an air guide plate 130. An air inlet 124, which is connected with the inflow pipe 129, is formed to the cyclone body 121. The air outlet 125 of the air guide plate 130 is formed to have a diameter smaller than an inner diameter of the cyclone body 121. Below the air guide plate 130 is disposed an air introducing blade 132. The air introducing blade 132 is formed, so that it is continuously extended by a certain distance in a shape that a height thereof is gradually lowered in a circumferential direction, for example, in a spiral shape, around the grill member 127. Accordingly, the air flows in through the air inlet 124 is guided by the air introducing blade 132, so that it flows into the cyclone chamber 122 while forming a whirling current.

The inflow pipe 129, which forms an air inflow part, guides the air laden with dust or dirt to flow into the cyclone chamber 122. As illustrated in FIG. 1, the inflow pipe 129 is formed, so that it is connected to the cyclone body 121 in a tangential inlet shape through which the air laden with the dust or dirt flows into the cyclone body 121 while coming in contact directly with an inner circumferential surface of the cyclone body 121 after passing through the air inlet 124 of the cyclone body 121. An inlet 126 provided on the outside of the inflow pipe 129 has a non-circular cross section.

The grill member 127 is joined with the inside of the air introducing blade 132 of the air guide plate 130 at the upper part of the cyclone body 121. The grill member 127 blocks dust or dirt centrifugally separated from the air in the cyclone body 121 from flowing backward and coming out of the cyclone body 121 toward the air outlet 125. The grill member 127 is provided with a grill body 131 having a plurality of minute penetrated holes. The grill body 131 at a top end thereof is opened, and has a cylinder shape. The top end of the grill body 131 is joined to the inside of the air introducing blade 132, so that it communicates with the air outlet 125 of the air guide plate 130. The lower end of the grill body 131 is blocked, and has an opening 128 through which a top of a compressing plate 181 and a threaded axis 191 of a lifting and lowering unit 190 to be described later penetrate.

The cover member 149 is joined to the air guide plate 130 to cover the air guide plate 130. An air discharging pipe 145 is formed on an upper part of the cover member 149. The air discharging pipe 145 guides the air discharged from the cyclone 120 through the air outlet 125 to discharge to the outside of the cyclone dust separating apparatus 100.

The dust bin unit 150 collects and stores the dust or dirt centrifugally separated from the air by the cyclone 120. The dust bin unit 150 is made up of a dust bin 151 in the form of a cylinder, a top end of which is opened and a bottom end of which is blocked. To easily remove the collected and stored dust or dirt, the dust bin 151 is detachably joined to the lower part of the cyclone body 121 of the cyclone 120.

The dust compressing apparatus 180, which compresses the dust or dirt randomly and loosely collected and stored in the dust bin 151, includes a compressing plate 181, a lifting and lowering unit 190, and a driving motor 196.

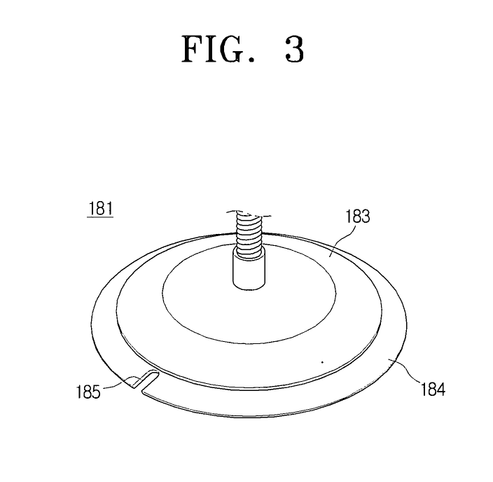

The compressing plate 181, which compresses the dust or dirt collected and stored in the dust bin 151, is disposed below the grill member 127 in the cyclone body 121. As illustrated in FIGS. 2 and 3, the compressing plate 181 can be formed of a circular plate 183 having a flat undersurface. At this time, preferably, but not necessarily, the circular plate 183 has a rubber lip 184 formed on a circumferential edge thereof to be flexible when it compresses the dust or dirt. In addition, preferably, but not necessarily, to allow the dust or dirt to pass between the dust bin 151 and the circular plate 183 and then to be collected and stored in the dust bin 151, the circular plate 183 is formed in such a diameter that a circumferential edge of thereof, that is, the rubber lip 184, is spaced apart from the dust bin 151 and the cyclone body 121 with a certain gap. At this time, the circular plate 183 acts as a backward flow-preventing plate, which blocks the dust or dirt collected and stored in the dust bin 151 from scattering along with the whirling current again and flowing backward toward the grill body 131.

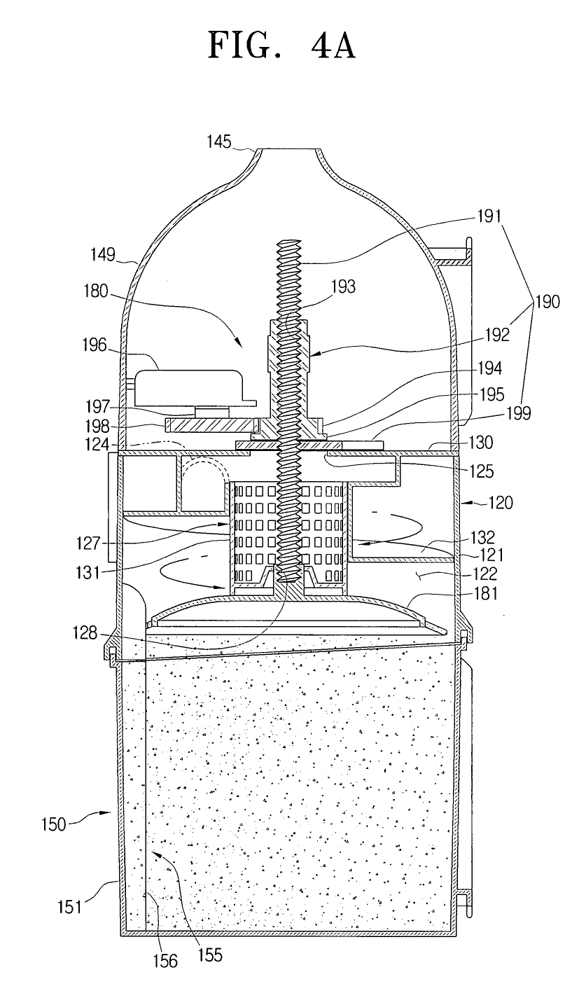

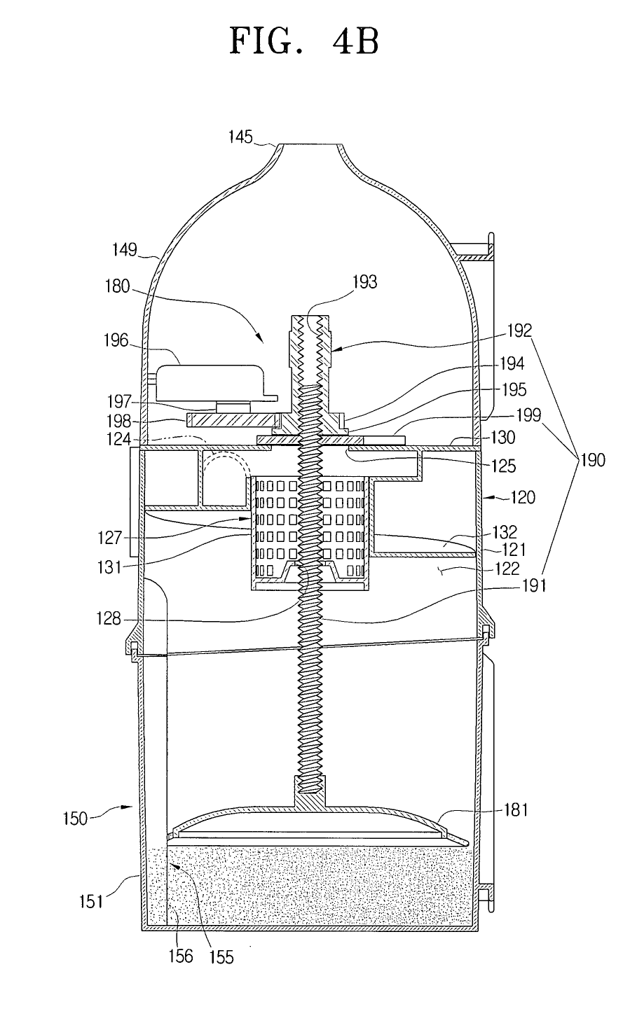

The lifting and lowering unit 190, which lifts and lowers the compressing plate 181, includes a threaded axis 191, a cylindrical gear 192, and a supporting bracket 199. The threaded axis 191 at a lower part thereof is connected to the compressing plate 181 and at an outer circumferential surface thereof has a thread. The threaded axis 191 is extended over the air outlet 125 of the air guide plate 130 located above the upper end of the grill body 131 while penetrating through the opening 128 of the lower end of the grill body 131 and a center of the grill body 131. The cylindrical gear 192 has a threaded hole 193 formed on an inner circumferential surface thereof to accommodate the threaded axis 191 and to engage with the threaded axis 191. The threads of the threaded axis 191 and the threaded hole 193 are formed, so that the threaded axis 191 is lowered when the cylindrical gear 192 is rotated in one direction, for example, a clockwise direction (see FIG. 4B), and lifted when the cylindrical gear 192 is rotated in the other direction, that is, a counterclockwise direction (see FIG. 4A). The cylindrical gear 192 has outer circumferential teeth 194 formed on an outer circumferential surface thereof to engage with a driving gear 198 of the driving motor 196.

To prevent the cylindrical gear 192 from raising along the threaded axis 191 when the cylindrical gear 192 is rotated in one direction, that is, the clockwise direction, a raised annular portion 195 is formed below the outer circumferential teeth 194 of the cylindrical gear 192. The cylindrical gear 192 is rotatably supported on the supporting bracket 199. The supporting bracket 199 acts to prevent the cylindrical gear 192 from lowering along the threaded axis 191 through the air outlet 125 when the cylindrical gear 192 is rotated in the other direction, that is, the counterclockwise direction by the driving gear 198, as well as to rotatably support the cylindrical gear 192. As illustrated in FIG. 1, the supporting bracket 199 is formed in a Y-lettered shape, and fixed on the air guide plate 130 of the cyclone body 121.

Also, to prevent the threaded axis 191 from rotating along with the cylindrical gear 192 when the cylindrical gear 192 is rotated by the driving gear 198, a rotation-preventing guide 155 is disposed between the compressing plate 181 and the cyclone body 121 and between the compressing plate 181 and the dust bin 151. The rotation-preventing guide 155 can be made up of two guide ribs 156 vertically formed on and projected from an inner circumferential surface of the lower part of the cyclone body 121 and an inner circumferential surface of the dust bin 151, respectively, and a guide groove 185 formed in the compressing plate 181 to accommodate and guide the guide ribs 156. Accordingly, the guide ribs 156 are inserted into the guide groove 185, so that it guides the compressing plate 181 to move only in upward and downward directions along with the threaded axis 191 without rotating when the cylindrical gear 192 is rotated by the driving gear 198 to lift and lower the threaded axis 191.

Here, although the guide ribs 156 are illustrated and explained as the two guide ribs 156 vertically formed on the inner circumferential surface of the lower part of the cyclone body 121 and the inner circumferential surface of the dust bin 151, respectively, it can be made up of a single rib vertically formed on the inner circumferential surface of the dust bin 151 and extended to the lower part of the cyclone body 121.

The driving motor 196, which drives the lifting and lowering unit 190 to lift and lower the compressing plate 181, is fixed to an inner surface of the cover member 149. The driving motor 196 is provided with a driving axis 197, which has a driving gear 198 formed to engage with the outer circumferential teeth 194 of the cylindrical gear 192.

Accordingly, when the cylindrical gear 192 is rotated in one direction, that is, the clockwise direction, by the driving gear 198 engaged with the outer circumferential teeth 194 as a control unit (not illustrated) drives the driving motor 196, the threaded axis 191 and the compressing plate 181 connected thereto are lowered down. To the contrary, when the cylindrical gear 192 is rotated in the other direction, that is, the counterclockwise direction, by the driving gear 198, the threaded axis 191 and the compressing plate 181 connected thereto are lifted up.

At this time, the rotation of the driving motor 196 in the compressing operation is controlled by the control unit, which detects a load of the driving motor 196. That is, when the driving motor 196 is rotated no longer after the compressing plate 181 has compressed the dust or dirt, it suffers an overload. At this time, the control unit detects a change of current according to a change of load through corresponding circuits, so that it senses the overload of the driving motor 196 and stops driving the driving motor 196 and drives the driving motor 196 in a reverse direction.

Alternatively, instead of controlling by detecting the load of the driving motor 196, the rotation of the driving motor 196 in the compressing operation can be controlled by a limit switch (not illustrated), which is disposed at a target position where the dust or dirt is to be compressed in the dust bin 151 so as to be operated by the compressing plate 181. In this case, if the compressing plate 181 operates the limit switch, the control unit stops driving the driving motor 196 and drives the driving motor 196 in a reverse direction.

As described above, the cyclone dust separating apparatus 100 of the present disclosure is configured, so that the dust compressing apparatus 180 having a relatively simple structure automatically ascends or descends the compressing plate 181 through the lifting and lowering unit 190, which is operated by the driving motor 196, thereby allowing the compressing plate 181 to compress the dust or dirt collected and stored in the dust bin 151. Accordingly, the problem of compressing the dust or dirt, where the user should manually operate the compressing plate through the operating handle or the griping part as in the conventional apparatus can be addressed.

Hereinafter, an operation of the cyclone dust separating apparatus 100 to which the dust compressing apparatus according to the exemplary embodiment of the present disclosure is applied and constructed as described above will now be explained in detail with reference to FIGS. 1 through 4B.

Air laden with dust or dirt is flowed into the cyclone chamber 122 through the air inlet 124 via the inflow pipe 129, due to a suction force of a suction motor (not illustrated) of the vacuum cleaner directly or indirectly connected to the air discharging pipe 145. The flowed-in air is lowered along the air introducing blade 132 while forming a whirling current. The dust or dirt included in the air is centrifugally separated from the air and falls down, so that it is collected and stored in the dust bin 151 of the dust bin unit 150. And, the dust-removed air raises while passing through the grill member 127, and comes out of the air outlet 125. Here, dust or dirt larger than the minute penetrated holes of the grill member 127 is not flowed into the grill member 127, but filtered. The air raised through the air outlet 125 is discharged to the outside of the cyclone dust separating apparatus 100 through the air discharging pipe 145 of the cover member 149.

After the cleaning operation is completed as described above, if the user wants to compress the dust or dirt collected and stored in the dust bin 151 as illustrated in FIG. 4A with the compressing plate 181, she or he pushes down a compression-executing button (not illustrated) of an operating panel (not illustrated) of the vacuum cleaner. According to this, the control unit drives the driving motor 196 in a counterclockwise direction. Here, instead of driving the driving motor 196 when the user pushes down the compression-executing button, the control unit can be set to automatically drive the driving motor 196 when a dust detecting sensor (not illustrated) installed at a certain height in the dust bin 151 is operated.

As the driving motor 196 is driven in the counterclockwise direction, the cylindrical gear 192 having the outer circumferential teeth 194 engaged with the driving gear 198 is rotated in a clockwise direction. As a result, the threaded axis 191 is lowered, and the compressing plate 181 fixed to the lower end of the threaded axis 191 is lowered along with the threaded axis 191, so that it compresses the dust or dirt collected and stored in the dust bin 151.

As illustrated in FIG. 4B, when the compressing plate 181 almost compresses or fully compressed the dust or dirt in the dust bin 151, the driving motor 196 suffers an overload. At this time, the control unit detects a change of current according to a change of load through the corresponding circuits, so that it senses the overload of the driving motor 196 and stops driving the driving motor 196.

And then, to restore the compressing plate 181 to an original position, the control unit drives the driving motor 196 in a reverse direction, that is, the clockwise direction. The cylindrical gear 192 having the outer circumferential teeth 194 engaged with the driving gear 198 is rotated in the counterclockwise direction. As a result, the threaded axis 191 and the compressing plate 181 fixed to the lower end of the threaded axis 191 are lifted up.

After that, the control unit drives the driving motor 196 for a time while the compressing plate 181 is lifted to a position illustrated in FIG. 4A, and then stops driving the driving motor 196. As a result, the dust compressing operation of the dust compressing apparatus 180 is completed.

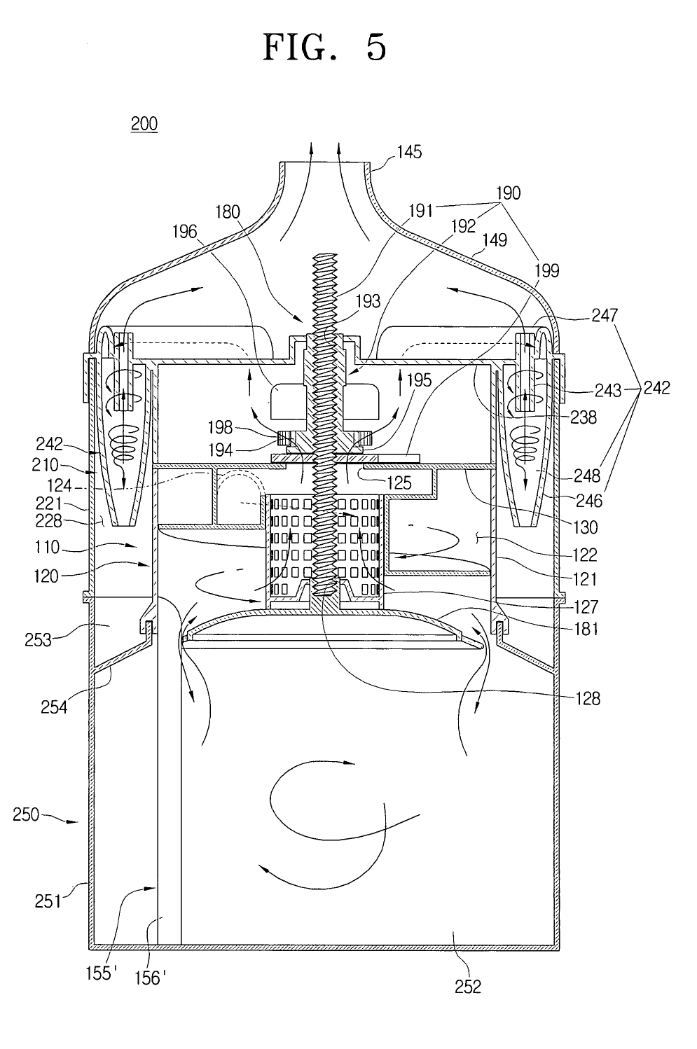

FIG. 5 is a cross-sectional view exemplifying another example of a cyclone dust separating apparatus 200 of a vacuum cleaner to which the dust compressing apparatus 180 according to the exemplary embodiment of the present disclosure is applied.

As illustrated in FIG. 5, the cyclone dust separating apparatus 200 includes a first cyclone unit 110, a second cyclone unit 210 joined to the first cyclone unit 110 above the first cyclone unit 110, a cover member 149 joined to the first cyclone 110 and the second cyclone unit 210 above the first cyclone unit 110 and the second cyclone unit 210, a dust bin unit 250 joined to the first cyclone unit 110 below the first cyclone unit 110, and a dust compressing apparatus 180. Here, since constructions of the first cyclone unit 110, the cover member 149 and the dust compressing apparatus 180 except the second cyclone unit 210, the dust bin unit 250 and a rotation-preventing guide 155′ of the dust compressing apparatus 180 are the same as those of the first cyclone unit 110, the cover member 149 and the dust compressing apparatus 180 of the cyclone dust separating apparatus 100 described with reference to FIGS. 1 through 4B, a detailed description thereof will be omitted.

The second cyclone unit 210 is provided with a housing 221, and a plurality of second cyclones 242.

The housing 221 is formed in an approximate cylinder shape, and disposed around a first cyclone body 121. On one side of an outer circumferential surface of the housing 221 is disposed an inflow pipe, which corresponds to the inflow pipe 129 of the dust separating apparatus 100 described with reference to FIGS. 1 through 4B. The inflow pipe guides air laden with dust or dirt to flow into a first cyclone chamber 122. The inflow pipe is formed, so that it is connected to the air inlet 124 of a first cyclone body 121 in a tangential inlet shape through which the air laden with the dust or dirt is flowed into the first cyclone body 121 while coming in contact directly with an inner circumferential surface of the first cyclone body 121 after passing through the housing 221.

Between the housing 221 and the first cyclone body 121 is formed a space part 228. In the space part 228 are disposed a plurality of second cyclones 242, which forms the second cyclone unit 210.

The plurality of second cyclones 242 are disposed in a circumferentially spaced-apart relation to one another around the first cyclone body 121. That is, the second cyclones 242 are around circumferential portions of the first cyclone body 121 except a circumferential portion to which the inflow pipe is formed.

Each of the plurality of second cyclones 242 includes a second cyclone chamber 248, a second cyclone body 246 forming the second cyclone chamber 248, an second air inflow part 247, and an outflow pipe 243.

The second cyclone body 246 is formed in the form of has a truncated cone, both upper and lower ends of which are opened. In the second cyclone chamber 248,air laden with dust or dirt is lowered while forming a whirling current and the dust or dirt included in the air is centrifugally separated from the air and discharged from the lower end of the second cyclone body 246. The opened upper end of the second cyclone body 246 is joined with a supporting body 238. On the supporting body 238 are installed a second air inflow part 247 in which the air discharged from the first cyclone unit 110 is flowed and an outflow pipe 243 through which the air from which the dust or dirt is centrifugally separated and removed in the second cyclone chamber 248 is discharged.

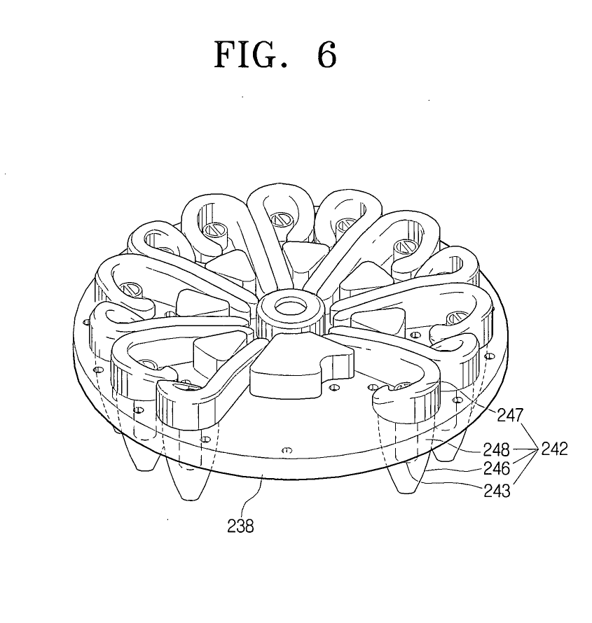

Each of the second air inflow parts 247, which introduces the air discharged from the air outlet 125 of the first cyclone unit 110 into the second cyclone chamber 248 of each of the second cyclones 242, is radially extended from a center of the supporting body 238 and connected to the second cyclone body 246 in a helical inlet shape through which the air is gradually approached in the form of a spiral toward a top end of the second cyclone body 246 from an upside of the top end of the second cyclone body 246 and then flowed into the second cyclone body 246 while coming in contact with the top end and the inner circumferential surface of the second cyclone body 246, as illustrated in FIG. 6.

Accordingly, as illustrated in FIG. 6, the air quickly raised toward the center of the supporting body 238 from the air outlet 125 of the air guide plate 130 of the first cyclone unit 110 is moved in all directions along each of the second air inflow parts 247. Each of the second cyclone bodies 246 guides the air taken in through each of the second air inflow parts 247 to continuously maintain a whirling current in each of the second cyclone chambers 248. For this, an air guide member (not illustrated) in the form of a spiral is installed on an inner surface of each of the second cyclone bodies 246. Each of the outflow pipes 243, as an air discharging part, penetrates through the inside of the corresponding second cyclone body 246 and extends downward by a certain distance. Each of the outflow pipes 243 discharges purified air from which minute dust or dirt is centrifugally separated and removed, toward the cover member 149.

The cover member 149 is joined to the supporting body 238 to cover the supporting body 238. An air discharging pipe 145 is formed on an upper part of the cover member 149. The air discharging pipe 145 guides the air discharged from each of the second cyclones 242 through each of the outflow pipes 243 to discharge to the outside of the cyclone dust-separating apparatus 200.

The dust bin unit 250 collects and stores the dust or dirt centrifugally separated from the air by the first and the second cyclones 120 and 242. The dust bin unit 250 is configured, so that a top end thereof is opened and a bottom end thereof is blocked. To easily remove the collected and stored dust or dirt, the dust bin unit 250 is detachably joined to lower parts of the first and the second cyclone units 110 and 210. The dust bin unit 250 is provided with a dust bin body 251 to form an appearance thereof, a first dust collecting chamber 252 to collect the dust or dirt centrifugally separated from the air in the first cyclone 120, a second dust collecting chamber 253 to collect the dust or dirt centrifugally separated from the air in the second cyclones 242, and a partition 254 to divide the first and the second dust collecting chamber 252 and 253 from each other.

The rotation-preventing guide 155′ of the dust compressing apparatus 180 is made up of an elongated guide rib 156′ formed on a bottom of the dust bin 251 and extended to the lower part of the first cyclone body 121, and a guide groove 185 (see FIG. 3) 156′ formed in the compressing plate 181 to accommodate and guide the guide rib 156′. Accordingly, the guide ribs 156′ are inserted into the guide groove 185, so that it guides the compressing plate 181 to move only in upward and downward directions along with the threaded axis 191 without rotating when the cylindrical gear 192 is rotated by the driving gear 198 to lift and lower the threaded axis 191.

Now, an operation of the cyclone dust separating apparatus 200 to which the dust compressing apparatus according to the embodiment of the present disclosure is applied and constructed as described above will be explained in detail with reference to FIGS. 5 and 6.

Air laden with dust or dirt is flowed into the first cyclone chamber 122 through the air inlet 124 via the inflow pipe, due to a suction force of a suction motor (not illustrated) of the vacuum cleaner. The flowed-in air is lowered along the air introducing blade 132 while forming a whirling current. Relatively large dust or dirt included in the air is centrifugally separated from the air and falls down, so that it is collected and stored in the first dust collecting chamber 252 of the dust bin 251. And, the relatively large dust-removed air raises while passing through the grill member 127, and comes out of the air outlet 125. Here, dust or dirt larger than the minute penetrated holes of the grill member 127 is not flowed into the grill member 127, but filtered. The air raised through the air outlet 125 is dispersed while dashing against the supporting body 238, and proceeds into each of the second cyclone bodies 246 through the air inflow part 247 of each of the second cyclones 242. The air flowed into each of the second cyclone bodies 246 is induced to a whirling current by the outflow pipe 243 in each of the second cyclone chambers 248 of the second cyclones 242, so that minute dust or dirt is secondly separated from the air. That is, the flowed-in air is lowered while forming the whirling current, and thus the minute dust or dirt, which has not removed from the air in the first cyclone 120, is centrifugally separated from the air and falls down, so that it is collected into and stored in the second dust collecting chamber 253 of the dust bin 251. The dust-removed air is discharged through the respective outflow pipes 243 of the second cyclones 242, and the air discharged from the respective outflow pipes 243 is mixed and discharged to the outside of the cyclone dust separating apparatus 200 through the cover member 149 and the air discharging pipe 145.

After the cleaning operation is completed as described above, an operation of compressing the dust or dirt collected and stored in the dust bin 251 with the compressing plate 181 is the same as that of the cyclone dust separating apparatus 100 explained with reference to FIGS. 1 and 4B.

As apparent from the foregoing descriptions according to the exemplary embodiments of the present disclosure, the cyclone dust separating apparatus is configured, so that the dust compressing apparatus automatically ascends or descends the compressing plate through the lifting and lowering unit, which is operated by the driving motor, thereby allowing the compressing plate to compress the dust or dirt collected and stored in the dust bin. Accordingly, the problem of compressing the dust or dirt, where the user should manually operate the compressing plate through the operating handle or the griping part as in the conventional apparatus can be addressed.

Further, since the dust compressing apparatus according to the exemplary embodiments of the present disclosure has the relatively simple structure, the cyclone dust separating apparatus is advantageous in that it is relatively easy to fabricate.

Also, according to the exemplary embodiments of the present disclosure, the cyclone dust separating apparatus is configured, so that the dust compressing apparatus is located above the dust bin. Accordingly, to dump the dust or dirt compressed in the dust bin, there is no need to disassemble the dust compressing apparatus. Thus, the cyclone dust separating apparatus of the present disclosure is advantageous in that it is easy to empty the dust or dirt from the dust bin.

Although representative embodiments of the present disclosure have been shown and described in order to exemplify the principle of the present disclosure, the present disclosure is not limited to the specific embodiments. It will be understood that various modifications and changes can be made by one skilled in the art without departing from the spirit and scope of the disclosure as defined by the appended claims. Therefore, it shall be considered that such modifications, changes and equivalents thereof are all included within the scope of the present disclosure.

What is claimed is:

1. A dust compressing apparatus of a vacuum cleaner, comprising:
a compressing plate to compress dust or dirt collected in a dust separating apparatus;
a lifting and lowering unit connected to the compressing plate above the compressing plate to lift and lower the compressing plate; and
a driving motor to drive the lifting and lowering unit thus to lift and lower the compressing plate.

2. The apparatus as claimed in claim 1, wherein the compressing plate comprises a circular plate.

3. The apparatus as claimed in claim 2, wherein the circular plate comprises a rubber lip formed on a circumferential edge thereof.

4. The apparatus as claimed in claim 1, wherein the lifting and lowering unit comprises:
a threaded axis connected to the compressing plate and having a thread formed on an outer circumferential surface thereof;
a cylindrical gear having a threaded hole formed on an inner circumferential surface thereof to engage with the threaded axis and outer circumferential teeth formed on an outer circumferential surface thereof to engage with a driving gear of the driving motor; and
a supporting bracket to rotatably support the cylindrical gear.

5. The apparatus as claimed in claim 4, wherein the cylindrical gear further comprises a raised portion formed below the outer circumferential teeth.

6. The apparatus as claimed in claim 4,
wherein the dust separating apparatus comprises a first cyclone unit to separate dust or dirt from air drawn in through an air inflow part, and a dust bin unit disposed below the first cyclone unit and having a dust bin in the form of cylinder to collect and store the dust or dirt separated from the air in the first cyclone unit,
wherein the compressing plate comprises a circular plate formed in such a diameter that a circumferential edge thereof is spaced apart from the dust bin with a certain gap.

7. The apparatus as claimed in claim 6,
wherein the first cyclone unit comprises a single first cyclone,
wherein the first cyclone comprises a cyclone body having an air inflow part formed therein, and a grill member disposed in the cyclone body having a cylindrical shape, a lower end of which is choked and an upper end of which is open, and having a plurality of penetrated holes,
wherein the circular plate is disposed below the grill member, the threaded axis is extended over the upper end of the grill member and penetrates through the grill member, and the supporting bracket is disposed on an air guide plate connected with an upper part of the cyclone body.

8. The apparatus as claimed in claim 7, wherein the lifting and lowering unit has a rotation-preventing guide disposed between the circular plate and at least one of the cyclone body and the dust bin so as to prevent the threaded axis from rotating along with the cylindrical gear.

9. The apparatus as claimed in claim 8, wherein the rotation-preventing guide comprises:
a guide rib vertically formed on at least one of the cyclone body and the dust bin; and
a guide groove formed in the circular plate to accommodate and guide the guide rib.

10. The apparatus as claimed in claim 1, wherein the dust separating apparatus further comprises a second cyclone unit having a plurality of second cyclones, wherein said plurality of second cyclones is disposed above and/or around the first cyclone unit.
